(19) United States
(12) Patent Application Publication
(10) Pub. No.: US 2011/0283931 A1
(43) Pub. Date: Nov. 24, 2011

(54) Submarine Renewable Energy Generation System Using Ocean Currents

(76) Inventors: Vladimir Moldovanu, Fort Myers, FL (US); James Richard McCoy, JR., Manchester, TN (US)

(21) Appl. No.: 13/193,954

(22) Filed: Jul. 29, 2011

(51) Int. Cl. F03B 13/10; B63G 8/00

(52) U.S. Cl. 114/312

(57) ABSTRACT

A system for generating electrical energy for a submarine using ocean currents includes a turbine mounted to the exterior hull that is comprised of a rotor, impelled by the ocean current and drives rotation of a generator for generating electrical energy. The submarine is configured with a pair of selectively extendable braking panels on either side of the submarine's hull.

### BACKGROUND

1. Field

The present invention relates generally to renewable, hydro-electric energy generation, and in particular to renewable hydro-electric energy generation for submarine ships.

2. Description of the Problem and Related Art

The power of moving water has long been harnessed and converted to other useful forms of energy, beginning with the water wheel. Water driven turbines have long been employed in dams to renewably generate electrical energy. Recently, sub-surface turbines have been developed to use ocean currents to generate electrical energy, for example, the “SeaGen” turbine, built by Marine Current Turbines, Ltd, of Bristol, United Kingdom. A further example, is that disclosed in U.S. patent application Ser. No. 11/998,593 by Kejha, which teaches an ocean current-powered, turbine anchored to the ocean floor. In these and other examples, it can be seen that efforts to convert ocean currents to energy have only been employed on stationary fixtures. The major advantage of using a fixed turbine is the relative force of the current against the turbine is greatest, causing the greatest amount of turbine rotation, generating greater energy.

In contrast, a major advantage of submarines in military operations is that they are difficult to detect. Their stealth depends on being able to operate as quietly as possible under the surface of the ocean. This is best done using electric motors. However, current battery technology is not efficient enough to allow the ship to run at long intervals underwater (days.) Some submarines use a diesel power plant for propulsion on the surface of the ocean. During this time on the surface, while running the diesel engines, electric batteries, used for propulsion and power under water may be charged. However, this method has several drawbacks. First, while the diesel-powered ship is on the surface, it is more vulnerable to detection as it can be seen and it is extremely noisy. Second, operational range of a diesel submarine is limited. The diesel submarines conduct naval operation close to shores because of refueling needs.

To overcome this limitation, nuclear submarines were developed that allowed long under surface periods so that detection is decreased, and long range which decreases logistic stress. However, a nuclear submarine costs much more than a diesel submarine or an electrically powered submarine. And, while the energy generated from a nuclear reactor is tremendous, it comes at an environmental cost in the disposal of the spent, radioactive nuclear fuel.

Accordingly, a submarine with an electric motor, able to transit long distances underwater without surfacing or returning to port to recharge or refuel would be advantageous.

### SUMMARY

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein.

The present disclosure is directed to a submarine with a generator adapted to convert energy from ocean currents into electric energy for powering the ship.

A submarine according that described hereinbelow includes an ocean current turbine mounted to exterior of the aft section of the sail of the submarine. The turbine is also preferably retractable.

The ship is also configured with extendable panels that serve to brake the forward motion of the ship when the turbine is deployed.

These and other embodiments of the present invention will also become readily apparent to those skilled in the art from the following detailed description of the embodiments having reference to the attached figures, the invention not being limited to any particular embodiment(s) disclosed.

### BRIEF DESCRIPTION OF THE DRAWINGS

Embodiments of the invention are described with reference to the accompanying drawings. In the drawings, like reference numbers indicate identical or functionally similar elements. It is to be understood that the drawings are not to scale.

FIG. 1A is a side view (from starboard) an exemplary submarine according to an embodiment of the invention;

FIG. 1B is a second side view of the exemplary submarine of FIG. 1A with the braking panels extended;

FIG. 2 is a view from the stern of the exemplary ship;

FIG. 3 is a top view of the exemplary ship;

FIG. 4 is an isolated, top view of an exemplary extended braking panel;

FIG. 5 is the extended braking panel from the stern view;

FIG. 6 is a functional schematic of an exemplary electrical distribution system for use with an embodiment of the invention;

FIG. 7 is a side view of an exemplary submarine illustrating another embodiment of the invention; and

FIG. 8 is a top view of an exemplary submarine according to another embodiment of the invention.

### DETAILED DESCRIPTION

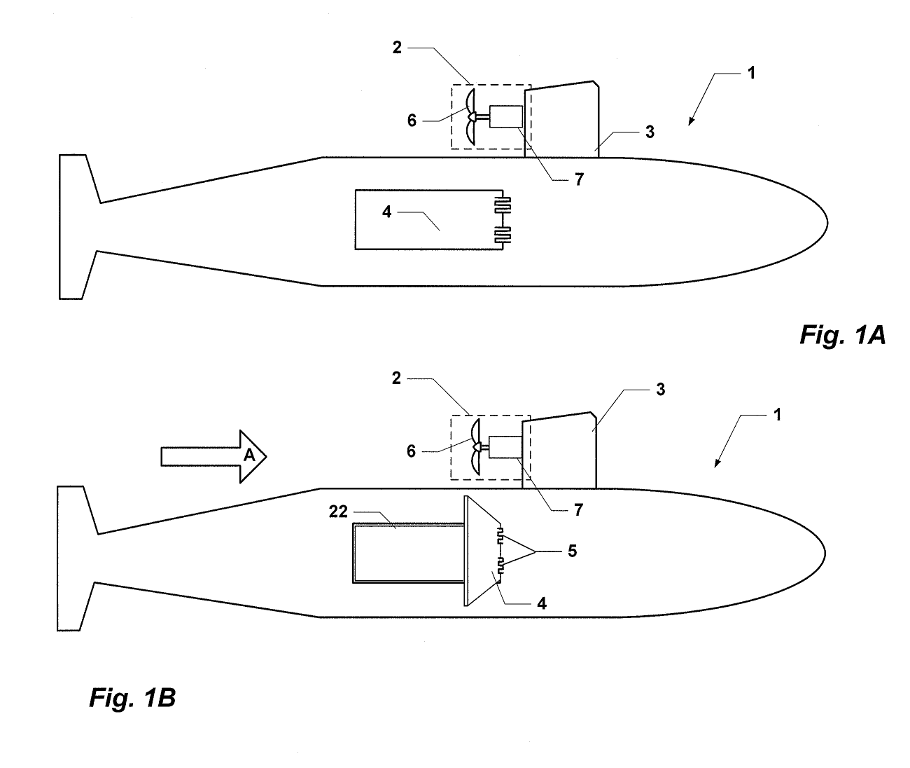

The various embodiments of the present invention and their advantages are best understood by referring to FIGS. 1A through 8 of the drawings. The elements of the drawings are not necessarily to scale, emphasis instead being placed upon clearly illustrating the principles of the invention. Throughout the drawings, like numerals are used for like and corresponding parts of the various drawings.

This invention may be provided in other specific forms and embodiments without departing from the essential characteristics as described herein. The embodiments described above are to be considered in all aspects as illustrative only and not restrictive in any manner. The following claims rather than the foregoing description indicate the scope of the invention.

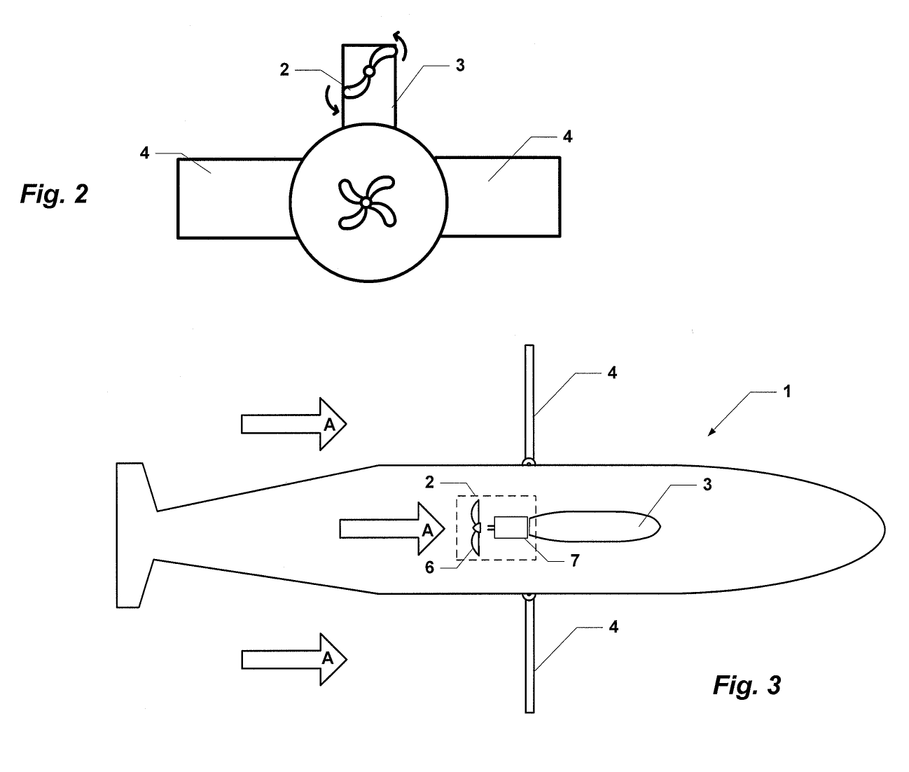

FIG. 1A depicts the starboard side of an exemplary submarine 1 having a turbine 2 mounted to the hull on the aft portion of the sail 3. The turbine 2 is comprised of a rotor 6 the rotation of which drives a generator 7. The submarine 1 includes a panel 4 along the side of the hull, shown in a stowed position, preferably formed to conform to the contours of the hull. An opposing panel is disposed along the port side (shown in FIGS. 2 & 3). The panel 4 may be hingedly connected to the submarine hull, with suitable hinges 5, and configured for selective extension and retraction with suitable actuators and controls, as would be known in the art.

FIGS. 1B through FIG. 3 illustrate the submarine 1 with the panel 4 in an extended position. When the ocean current energy generation system is to be used, the submarine 1 maneuvers so that its bow is down-current. The direction of the current is shown in the drawings using reference arrow “A”. The panels 4 are extended on both sides in order to brake the forward motion of the submarine 1, and the rotor 6 is allowed to turn, thereby turning the generator 7. The generator 7 is connected to the submarine's power systems, and/or batteries. Preferably, the rotor 6 is capable of being locked to prevent spinning while the system is not in use. Alternatively, the turbine 2 may be made to be retractable. In addition, some designs may choose to mount rotor 6 on the exterior hull on a rotating shaft that extends through the hull and drives a generator 7 that is located in an interior compartment.

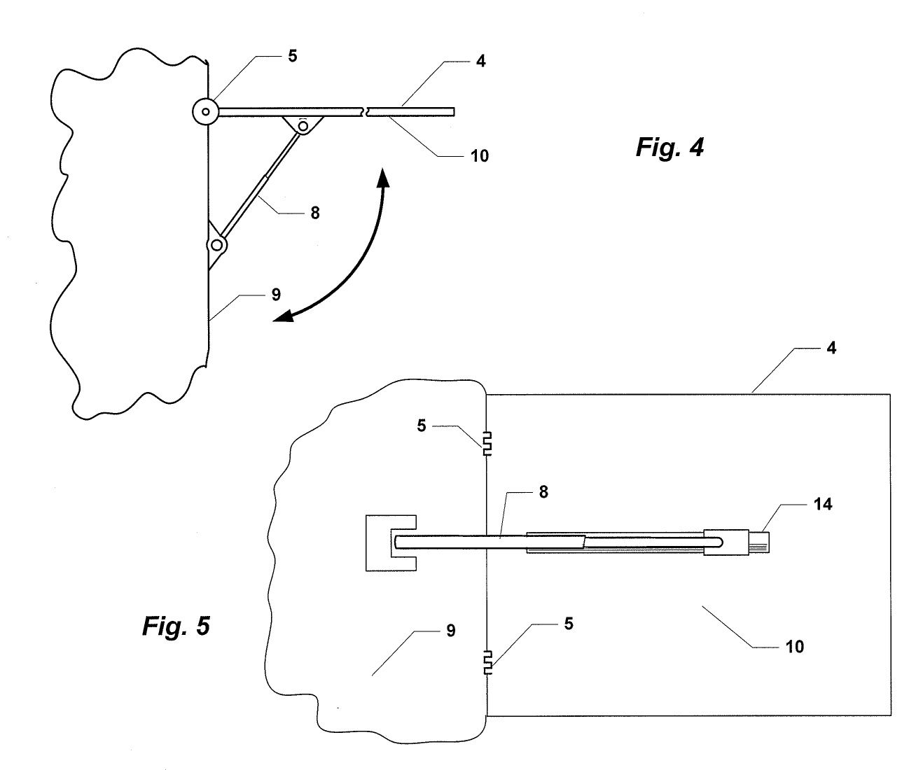

FIGS. 4 and 5 show an exemplary means to extend the panels 4 with an actuator 8 connected to the hull 9 of the submarine and the interior face 10 of the panel 4. As those skilled in the art would readily see, actuator 8 may be connected to the hull 9 and the panel 4 in a variety of ways. For example, one end 11 of the actuator 8 may be pivotally attached to the hull 9, and the opposing end 12 may be pivotally attached to a trolley 13 that is slidably engaged with a track 14 on the interior face 10 of the panel 4. In addition, panels 4 preferably are seated in a recess 22 in the hull so that when retracted, their contribution to drag of the submarine is minimized.

Panels 4 are dimensioned to be able to brake the ship's forward motion so that the velocity of the ocean current is greater than that of the submarine 1. In addition it should be understood that the submarine 1 may be equipped with more than one pair of braking panels 4, each of which may be selectively extendable or retractable.

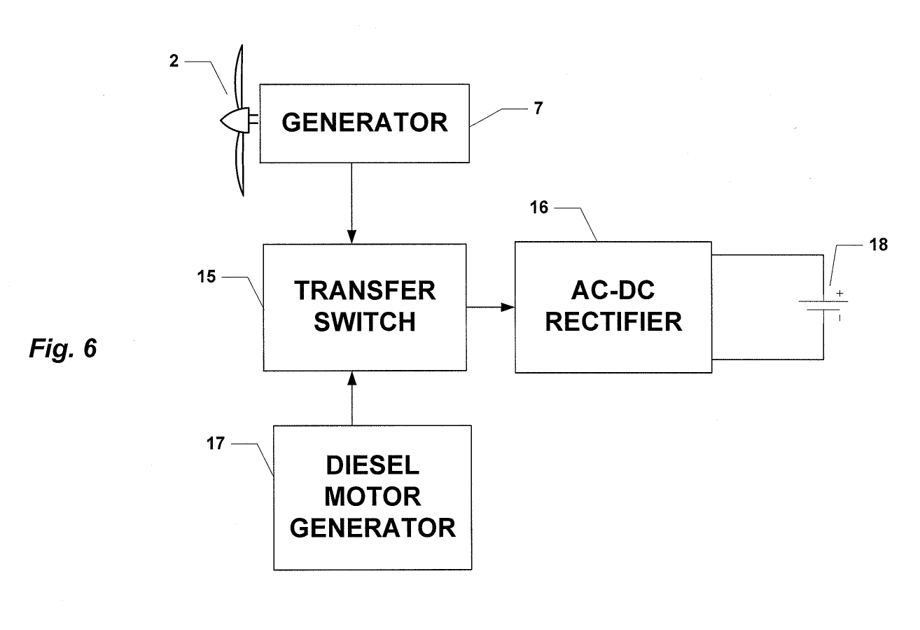

Referring now to FIG. 6, the functional components of the energy distribution system include the generator 7, driven by the rotor 6. Energy generated by the generator 7 is transmitted to a storage battery 18, through a rectifier 16. The system may be installed as a “retro-fit” to existing diesel submarines. In such a configuration, the generator 7 is coupled to a transfer switch 15 which is also coupled to the storage battery 18. An existing diesel motor-driven generator 17 is also coupled to the transfer switch 15. In this way, respective energy sources may be selected to charge the storage battery 18.

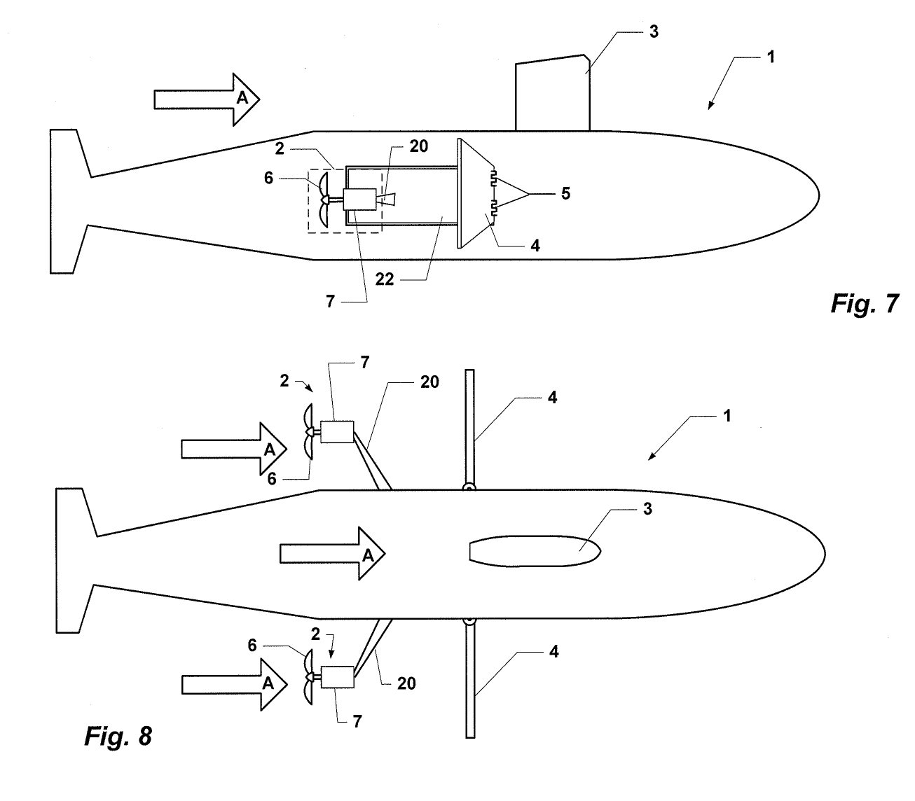

It will also be appreciated that the invention may be achieved with placing the turbine 2 at differing locations on the ship. For example, in FIGS. 7 & 8, the submarine 1 is configured with the braking panels 4 as described above. However, in this embodiment, turbine 2, comprising a rotor 6 coupled to a generator 7, is mounted on a support 20 and is located on the side exterior hull of the submarine 1. Again, rotor 6 drives rotation of the generator 7 when impelled by an ocean current. It will also be appreciated that this adaptation allows for more than one turbine to be used (FIG. 8). It will be appreciated that the support 20 is preferably selectively extendable so that when not in use and the submarine is making way, the exterior hull of the submarine is as streamlined as possible. It will also be appreciated that locating the turbine/support structure (2, 20) within the recess 22 allows the panel 4 to cover the retracted structure (2, 20) in order to maintain reduced drag.

As described above and shown in the associated drawings, the present invention comprises a system for generating energy for a submarine using ocean currents. While particular embodiments of the invention have been described, it will be understood, however, that the invention is not limited thereto, since modifications may be made by those skilled in the art, particularly in light of the foregoing teachings. It is, therefore, contemplated by the appended claims to cover any such modifications that incorporate those features or those improvements that embody the spirit and scope of the present invention.

What is claimed is:

1. A system for generating electrical energy for a submarine using ocean currents, said submarine having an exterior hull, said system comprising:
a turbine mounted to exterior hull of said submarine, said turbine comprising a rotor and a rotor-driven generator and oriented to be rotated by an ocean current;
a storage battery coupled to said generator;
a pair of braking panels, each of said panels being selectively extendable and extending from either lateral side of said submarine hull.

2. The system for generating electrical energy for a submarine using ocean currents of claim 1, wherein said submarine includes a sail and wherein said turbine is mounted to said exterior hull of said sail.

3. The system for generating electrical energy for a submarine using ocean currents of claim 1, wherein said turbine is mounted to a retractable support.

4. The system for generating electrical energy for a submarine using ocean currents of claim 1, further comprising a transfer switch interposed between a diesel motor driven generator and said rotor-driven generator, said transfer switch having an output coupled to said storage battery.
